(19) United States
(12) Patent Application Publication
(10) Pub. No.: US 2003/0235242 A1
(43) Pub. Date: Dec. 25, 2003

(54) Testing a digital loop carrier

(75) Inventors: Paul L. Fitch, Raleigh, NC (US); William C. Meador, Raleigh, NC (US); Melvin Richard Phillips, Raleigh, NC (US); James Dunn, Wake Forest, NC (US)

Correspondence Address: Fogg Slifer Polglaze Leffert & Jay, P.A., P.O. Box 581009, Minneapolis, MN, 55458-1009, US

(73) Assignee: ADC DSL Systems, Inc.

(21) Appl. No.: 10/176,810

(22) Filed: Jun. 20, 2002

(51) Int. Cl. H04B 3/46

(52) U.S. Cl. 375/224; 455/226.1

(57) ABSTRACT

A method for testing a digital loop carrier is provided. The method includes initiating at least one test with a test request, communicating the test request to a remote terminal of the digital loop carrier over a digital communication channel, conducting the at least one test at the remote terminal and reporting the results of the at least one test over the digital communication channel.

### TECHNICAL FIELD

The present invention relates to the field of telecommunications and, in particular, to testing a digital loop carrier.

### BACKGROUND

Telecommunication systems provide communication between subscriber equipment, e.g., telephones, computer modems, etc. The telephone system developed around the use of narrow-band analog communications to carry voice traffic between subscribers. Classically, telephones were connected to centralized switches, often referred to as the “central office,” over a pair of copper wires, colloquially referred to as a “twisted pair,” “loop” or “customer drop.” These twisted pairs have an inherent limitation in that signals can be transmitted and received with acceptable levels of fidelity only over a limited distance. This limitation imposes a maximum allowable distance between subscribers and the central office.

Over time, digital technology for aggregating and transporting communication signals over longer distances was developed. Through the use of digital transport technology, the reach of central office equipment was extended. One development in this area included the digital loop carrier. A conventional digital loop carrier includes a central office terminal (COT) and a remote terminal (RT). The central office terminal connects to or is integrated with a digital switch at a central office. The remote terminal is located a distance from the central office and terminates a plurality of twisted pairs or customer drops. The central office terminal is coupled to the remote terminal over a digital link such as a T1, E1 or other appropriate digital communication line that aggregates a number of communications channels using, for example, a time division multiplex (TDM) technique.

As with conventional customer drops, the twisted pairs connected to the remote terminal are tested periodically to assure proper operation. To accomplish this, an additional twisted pair, referred to as a “bypass pair,” is provided between the central office terminal and the remote terminal. Test equipment at the central office connects to the digital switch as well as to the bypass pair at the central office terminal. When a customer loop is to be tested, the test equipment applies a start voltage to the line through a metallic connection through the digital switch. A line card in the central office terminal detects the start voltage. The line card signals the remote terminal that a test is requested. The remote terminal also connects the customer drop to the bypass pair. This creates a metallic connection between the test equipment in the central office through the COT to the RT and eventually to the customer drop. The test equipment then tests the customer drop over the bypass pair. The RT provides a resistive signature to the test equipment indicating the results of the test when the tests are completed. The test equipment removes the starting voltage from the line being tested and the normal service is restored.

Unfortunately, the requirement to test the customer drop of a digital loop carrier system limits the distance between the COT and the RT due to the use of the bypass pair. Since signals must be transmitted over the bypass pair, the RT cannot be located beyond the range imposed by signaling requirements for the bypass pair. This range is typically much shorter than the range of the digital communication medium, e.g., T1 or E1 lines, coupled between the COT and RT.

Therefore, there is a need in the art for a digital loop carrier system that allows for testing of the customer drop with improved distance between the central office terminal and the remote terminal.

### SUMMARY

Embodiments of the present invention accomplish testing of customer drops of a digital loop carrier system with increased distance between the central office terminal and remote terminal by eliminating the bypass pair. For example, in one embodiment, signaling normally carried over the bypass pair is presented to the central office terminal over a digital communication channel between the central office terminal and the remote terminal. In one embodiment, the digital communication channel is accomplished using the Concentrator Field Bits of the TR-08 standard. In other embodiments, other fields are used to carry the data in the digital communication channel. Advantageously, through the use of the digital communication channel, the need for the bypass pair is removed.

In one embodiment, a method for testing a digital loop carrier is provided. The method includes initiating at least one test with a test request, communicating the test request to a remote terminal of the digital loop carrier over a digital communication channel, conducting the at least one test at the remote terminal and reporting the results of the at least one test over the digital communication channel.

### BRIEF DESCRIPTION OF THE DRAWINGS

FIG. 1 is a block diagram of one embodiment of a digital loop carrier with improved testing capabilities according to the teachings of the present invention.

FIG. 2 is a block diagram of another embodiment of a digital loop carrier with improved testing capabilities according to the teachings of the present invention.

FIG. 3 is a flow chart of one embodiment of a process for testing a digital loop carrier according to the teachings of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention provide for testing of customer drops in a digital loop carrier system without the use of a bypass line between a central office terminal and a remote terminal. Embodiments of the present invention accomplish control of testing and communication of test results over a digital communication link instead of a bypass line. This provides the advantage of allowing the remote terminal and the central office terminal to be located further apart than in existing systems with bypass lines.

In Technical Reference TR-TSY-000008, “Digital Interface Between the SLC96 Digital Loop Carrier System And A Local Digital Switch” (commonly referred to as TR-08), a data link frame structure is defined for use in the digital loop carrier system. Part of this definition includes 11 bits that are used as Concentrator Field Bits. Some digital loop carrier systems, such as the PG-Flex^{Plus} system commercially available from ADC Telecommunications Systems, Inc. of Eden Prairie, Minn., do not use line concentration. Thus, these bits of the data link frame are not used. Therefore, in one embodiment, the Concentrator Field Bits are used as the digital communication channel or message channel from the Central Office Terminal (COT) to the Remote Terminal (RT) in the digital loop carrier system. In other embodiments, other reserved and un-used fields are used as the message channel. Using a message channel, mechanized line tests are completed on the digital loop carrier system without a bypass pair and with no limitation on the distance between the COT and RT. In one embodiment, the message channel also carries short messages between the COT and RT.

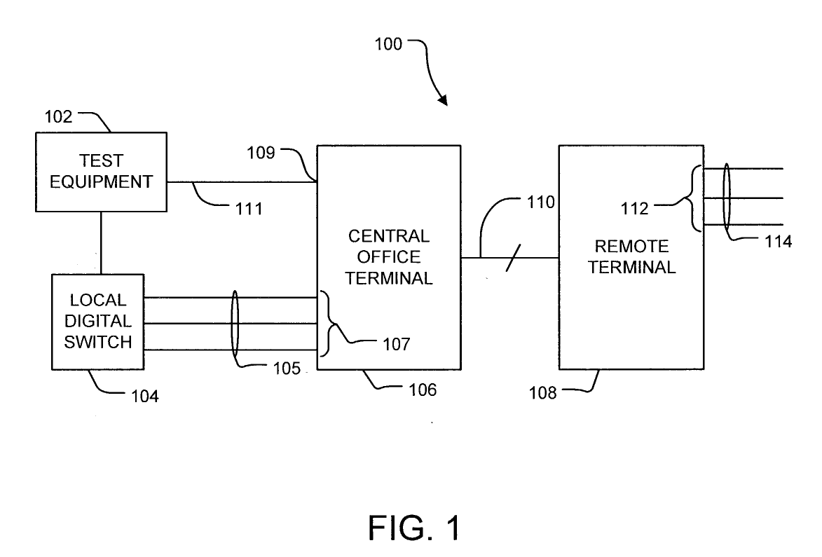

FIG. 1 is a block diagram of a digital loop carrier system, indicated generally at 100, according to the teachings of the present invention. System 100 has an improved testing capability compared to existing digital loop carrier systems.

System 100 communicates subscriber traffic and other information between central office terminal 106 and remote terminal 108. Central office terminal 106 is coupled to remote terminal 108 over one or more digital communication links 110. In one embodiment, the digital communication links 110 are time division multiplexed (TDM) links such as T1 or E1 links. In one embodiment, digital communication links 110 comprise four T1 (DS1) links.

Central office terminal 106 has a number of interfaces. First, central office terminal 106 has a link interface coupled to digital communication link 110. Central office terminal 106 also includes a switch interface 107. Switch interface 107 couples traffic between local digital switch 104, e.g., a class 5 switch, and central office terminal 106 over a plurality of voice frequency lines 105. Finally, central office terminal 106 includes a test interface 109. Test interface 109 connects to test equipment 102 over test bus 111. Test equipment 102 is also coupled to local digital switch 104.

Remote terminal 108 also includes a number of interfaces. First, remote terminal 108 includes a link interface that is coupled to digital communication link 110. Further, remote terminal 108 also includes subscriber interface 112. Subscriber interface 112 is coupled to a plurality of customer drops 114, e.g., a plurality of twisted pairs that provide service to a plurality of subscribers. Further, remote terminal 108 also includes a loop test function that is operable to perform one or more tests on customer drops 114.

In operation, test equipment 102 is operable to test customer drops of remote terminal 108 without the use of a bypass pair between central office terminal 106 and remote terminal 108. Test equipment 102 initiates the test by applying a voltage through switch 104 to a selected voice frequency line 105. When this voltage is applied, the central office terminal 106 sends a message to the remote terminal over a digital communication channel that a test is requested. In one embodiment, the digital communication channel uses an otherwise unused field in the data link frames sent over digital communication link 110. For example, with a digital loop carrier system that does not support concentration, the concentration field bits of a TR-08 frame are used to communicate messages between the remote terminal 108 and central office terminal 106 regarding the test of customer drops 114.

Remote terminal 108 conducts the requested test or tests on the selected customer drop 114. The results of the test or tests are reported to central office terminal 106 over the digital communication channel. At central office terminal 106, the test results are provided to test equipment 102 over test bus 111. Further, a test complete signal is sent from remote terminal 108 to central office terminal 106. When this is received, an appropriate resistive signature is applied to test bus 111. When received, test equipment 102 removes the test request voltage from the voice frequency pair 105 at digital switch 104 and normal service is restored.

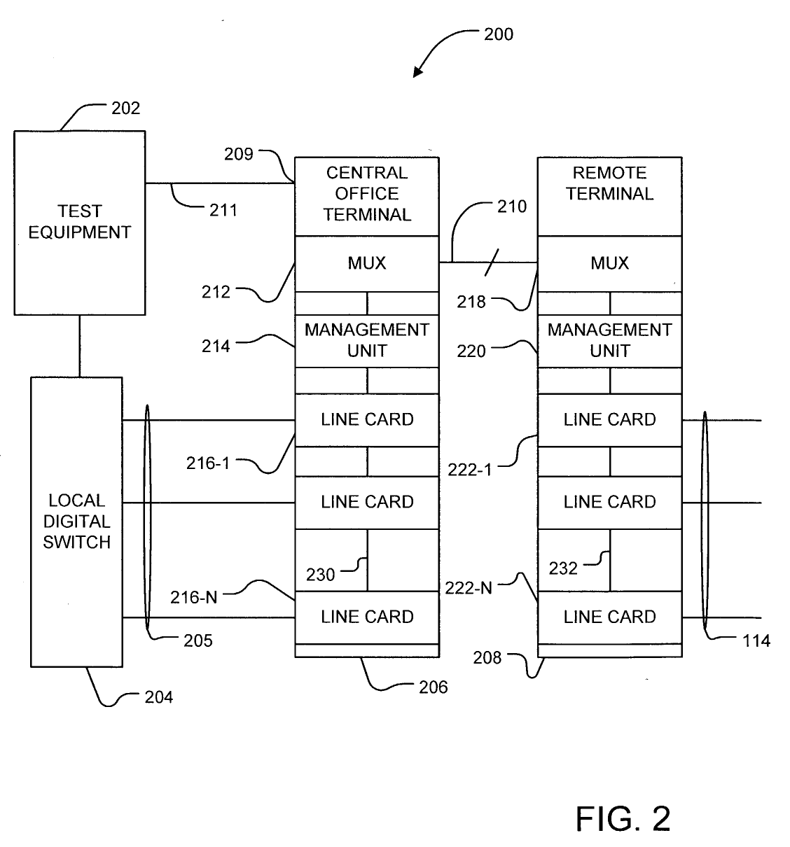

FIG. 2 is a block diagram of another digital loop carrier system, indicated generally at 200, according to the teachings of the present invention. System 200 has an improved testing capability compared to existing digital loop carrier systems.

System 200 communicates subscriber traffic and other information between central office terminal 206 and remote terminal 208. Central office terminal 206 is coupled to remote terminal 208 over one or more digital communication links 210. In one embodiment, the digital communication links 210 are time division multiplexed (TDM) links such as T1 or E1 links. In one embodiment, digital communication links 210 comprise four T1 (DS1) links.

Central office terminal 206 has a number of interfaces. First, central office terminal 206 has a link interface coupled to digital communication link 210. The link interface is coupled to multiplexer (MUX) 212. Central office terminal 206 also includes a switch interface. The switch interface couples traffic between local digital switch 204, e.g., a class 5 switch, and line cards 216-1 to 216-N of central office terminal 206 over a plurality of voice frequency lines 205. Finally, central office terminal 206 includes a test interface 209. Test interface 209 connects to test equipment 202 over test bus 211. Test equipment 202 is also coupled to local digital switch 204. Central office terminal 206 also includes a management unit 214. Management unit 214, line cards 216-1 to 216-N, and MUX 212 are coupled together over a backplane bus 230.

Remote terminal 208 also includes a number of interfaces. First, remote terminal 208 includes a link interface that is coupled to digital communication link 210. The link interface is coupled to multiplexer (MUX) 218. Further, remote terminal 208 also includes a subscriber interface. The subscriber interface is coupled to a plurality of customer drops 214, e.g., a plurality of twisted pairs through line cards 222-1 to 222-N. Customer drops 214 provide service to a plurality of subscribers. MUX 218, management unit 220, and line cards 222-1 to 222-N are coupled together over backplane bus 232.

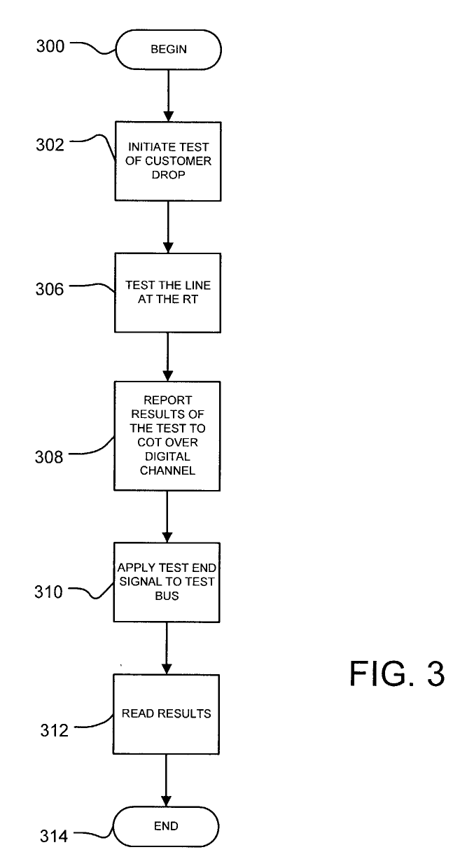

MUX 212 and MUX 218 are set to a “channel bank” mode. This mode establishes the digital communication channel or message channel between central office terminal 206 and remote terminal 208 using, for example, the otherwise unused concentrator field bits. The operation of the embodiment of FIG. 2 is described below with respect to the method of FIG. 3.

FIG. 3 is a flow chart of one embodiment of a method for testing a digital loop carrier according to the teachings of the present invention. The method begins at block 300. At block 302, the method initiates the testing of a customer drop or loop. This testing comprises one or more appropriate tests to evaluate selected aspects of the operation of the customer drop. In one embodiment, test equipment, e.g., test equipment 202, applies a test request voltage to a voice frequency (VF) pair at the COT, e.g., COT 206. The COT detects this voltage such as by line card 216-1 of COT 206. In one embodiment, several additional events happen at this point. First, the signaling being sent to the remote terminal, e.g., signaling sent to line card 222-1 of remote terminal 208, changes to the channel test signaling. Further, the line card at the COT, e.g., line card 216-1, sends a message to management unit 214 indicating the test has begun. The management unit, in turn, forwards this information to the multiplexer, e.g., MUX 212, at the COT. The multiplexer then forwards the test request as a message to the remote terminal over the message channel. This message is received, for example, at a multiplexer in the RT, e.g., MUX 218. This multiplexer then sends a message to its associated management unit, e.g., management unit 220 of remote terminal 208 over shelf backplane 232.

When test signaling is detected at the line card, e.g., line card 222-1 of remote terminal 208, the line card starts testing of the line at block 306. This includes one or more tests that are accomplished using existing or later developed techniques for testing the operation of the customer drop of the digital loop carrier.

In one embodiment, when the one or more tests are complete, the results are sent to the COT over the digital communication channel or message channel at block 308. In one embodiment, the results are first sent to the management unit of the RT, e.g., management unit 220 of remote terminal 208. The management unit of the remote terminal, e.g., RT 208, forwards the results to the multiplexer, e.g., multiplexer 218. The multiplexer sends these results back to the multiplexer at the COT, e.g., MUX 212, over the message channel. The multiplexer forwards the message to the management unit at the COT, e.g., management unit 214.

To indicate that the test is complete, the management unit at the COT applies the appropriate resistive signature to the test bus at block 310. This resistive signature is the result that the test equipment, e.g., test equipment 202, is looking for. When the test equipment reads the results over the digital communication channel, the test equipment then removes the test request voltage and ends the test.

Advantageously, this testing technique eliminates the bypass pair and removes the limitation on the distance between the COT and RT. This can give a significant increase in the customer service area for digital loop carriers.

What is claimed is:

1. A method for testing a digital loop carrier, the method comprising:
initiating at least one test with a test request;
communicating the test request to a remote terminal of the digital loop carrier over a digital communication channel;
conducting the at least one test at the remote terminal; and
reporting the results of the at least one test over the digital communication channel.

2. The method of claim 1, wherein initiating the test comprises applying a test request voltage to a voice frequency (VF) pair at a central office terminal.

3. The method of claim 1, wherein communicating the test request to a remote terminal and reporting the results comprise communicating messages in a selected field of a data link frame.

4. The method of claim 3, wherein communicating messages in a selected field comprises communicating messages in a field reserved for concentrator bits.

5. The method of claim 1, wherein communicating the test request to a remote terminal and reporting the results comprise transmitting messages over a time division multiplex (TDM) communication link.

6. The method of claim 1, and further comprising transmitting a test end signal over the digital communication channel at the completion of the at least one test.

7. The method of claim 2, and further comprising removing the test request signal from the voice frequency pair at the end of the at least one test.

8. The method of claim 1, and further monitoring a test bus for a signal indicating the end of the at least one test has been reached.

9. A digital loop carrier system with a loop test function, comprising:
a central office terminal having a switch interface, a link interface, and a test bus connection;
a remote terminal having a link interface and a plurality of customer interfaces and having the loop test function;
a digital communication link coupled between the link interfaces of the central office terminal and the remote terminal that is adapted to carry subscriber traffic and other signaling between the central office terminal and the remote terminal in data link frames; and
wherein a selected field of the data link frames is adapted to communicate messages between the central office terminal and the remote terminal related to testing customer drops at the plurality of customer interfaces.

10. The digital loop carrier of claim 9, wherein the digital communication link comprises at least one of a T1 and an E1 communication line.

11. The digital loop carrier of claim 9, wherein the central office terminal comprises:
a multiplexer, coupled to the link interface;
a management unit;
a plurality of line cards coupled to the switch interface; and
a backplane coupled to the multiplexer, the management unit and the plurality of line cards.

12. The digital loop carrier of claim 9, wherein the remote terminal comprises:
a multiplexer, coupled to the link interface;
a management unit;
a plurality of line cards coupled to the customer interfaces; and
a backplane coupled to the multiplexer, the management unit and the plurality of line cards.

13. The digital loop carrier of claim 9, wherein the selected field comprises a field reserved for concentrator bits.

14. The digital loop carrier of claim 9, wherein the selected field is adapted to communicate messages initiating and terminating the testing and to communicate messages indicating the results of the testing.

15. A method for testing a digital loop carrier, the method comprising:
initiating at least one test;
communicating a test request signal to a remote terminal of the digital loop carrier over a digital communication channel in a time division multiplexed (TDM) link;
conducting the at least one test at the remote terminal;
reporting the results of the at least one test over the digital communication channel; and
signaling an end to the testing when the at least one test is complete.

16. The method of claim 15, wherein initiating the test comprises applying a test request voltage to a voice frequency (VF) pair at a central office terminal.

17. The method of claim 15, wherein communicating the test request to a remote terminal and reporting the results comprise communicating messages in a selected field of a data link frame.

18. The method of claim 17, wherein communicating messages in a selected field comprises communicating messages in a field reserved for concentrator bits.

19. The method of claim 15, and further monitoring a test bus for a signal indicating the end of the at least one test has been reached.

20. A digital loop carrier system with a loop test function, comprising:
a central off terminal having a switch interface, a link interface, and a test bus connection;
a remote terminal having a link interface and a plurality of customer interfaces and having the loop test function;
a digital communication link supporting time division multiplex (TDM) communication coupled between the link interfaces of the central office terminal and the remote terminal that is adapted to carry subscriber traffic and other signaling between the central office terminal and the remote terminal in data link frames; and
wherein a field of the data link frame normally reserved for an un-used function is adapted to communicate messages between the central office terminal and the remote terminal related to testing customer drops at the plurality of customer interfaces.

21. A method of testing a digital loop carrier system without a bypass line between a central office terminal and a remote terminal, the method comprising:
testing a customer drop at the remote terminal; and
signaling the results of the test over a digital communication channel between the remote terminal and the central office terminal.

22. A method for testing a customer drop at a remote terminal, the method comprising:
receiving a request over a digital communication channel to conduct at least one test;
conducting the at least one test;
reporting the test results over the digital communication channel; and
indicating when the at least one test is complete over the digital communication channel.

23. The method of claim 22, wherein receiving the test request and reporting the test results comprise communicating messages in a selected field of a data link frame.

24. The method of claim 23, wherein communicating messages in a selected field comprises communicating messages in a field reserved for concentrator bits.

25. The method of claim 22, wherein receiving the test request and reporting the test results comprise transmitting messages over a time division multiplex (TDM) communication link.
